(19) United States
(12) Patent Application Publication
(10) Pub. No.: US 2008/0164865 A1
(43) Pub. Date: Jul. 10, 2008

(54) DISPLAY SYSTEM FOR AN AUTOMOTIVE VEHICLE

(75) Inventors: Kris Tomasson, Corona del Ma, CA (US); Brian White, Rancho Santa Margarita, CA (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/620,208

(22) Filed: Jan. 5, 2007

(51) Int. Cl. B60K 35/00; G01P 1/08

(52) U.S. Cl. 324/115; 340/441

(57) ABSTRACT

A display system for an automotive vehicle indicates a state of the vehicle by the position of an indicator bar. The indicator bar moves as the state of the vehicle changes.

### BACKGROUND OF THE INVENTION

1. Field of the Invention

The invention relates to display systems for automotive vehicles.

2. Discussion

A vehicle may include an engine operatively connected with at least one wheel to drive the wheel and thus move the vehicle.

A driver of an automotive vehicle may desire feedback on vehicle performance. Vehicle speed and engine speed may be parameters that influence vehicle performance.

### SUMMARY

Embodiments of the invention may take the form of a display system for an automotive vehicle. The system includes a sensor arrangement configured to determine a state of the vehicle and a display including indicia indicative of the state of the vehicle. The system also includes an indicator element associated with the display and operatively connected with the sensor arrangement such that the indicator element indicates the state of the vehicle by its position relative to the indicia. The indicator element translates in a first direction as the state of the vehicle increases, if the state of the vehicle is less than a first predetermined threshold, rotates as the state of the vehicle increases, if the state of the vehicle is greater than the first predetermined threshold and less than a second predetermined threshold, and translates in a second direction as the state of the vehicle increases, if the state of the vehicle is greater than the second predetermined threshold.

Embodiments of the invention may take the form of a speedometer system for an automotive vehicle. The system includes a display including indicia indicative of vehicle speed and an indicator element associated with the display and configured to indicate vehicle speed by its position relative to the indicia. The system also includes a looped belt attached with the indicator element and configured to cause the indicator element to translate in a first direction as vehicle speed increases, if the vehicle speed is less than a first predetermined vehicle speed, to rotate as the vehicle speed increases, if the vehicle speed is greater than the first predetermined vehicle speed and less than a second predetermined vehicle speed, and translate in a second direction as the vehicle speed increases, if the vehicle speed is greater than the second predetermined vehicle speed.

Embodiments of the invention may take the form of a tachometer system for an automotive vehicle having an engine. The system includes a display including indicia indicative of engine speed and an indicator element associated with the display and configured to indicate engine speed by its position relative to the indicia. The system also includes a looped belt attached with the indicator element and configured to cause the indicator element to translate in a first direction as engine speed increases, if the engine speed is less than a first predetermined engine speed, to rotate as the engine speed increases, if the engine speed is greater than the first predetermined engine speed and less than a second predetermined engine speed, and translate in a second direction as the engine speed increases, if the engine speed is greater than the second predetermined engine speed.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a perspective view of a display system for a vehicle in accordance with an embodiment of the invention.

FIG. 2 is an elevation view of a display system for a vehicle in accordance with an embodiment of the invention and shows its associated control system in block diagram format.

### DETAILED DESCRIPTION

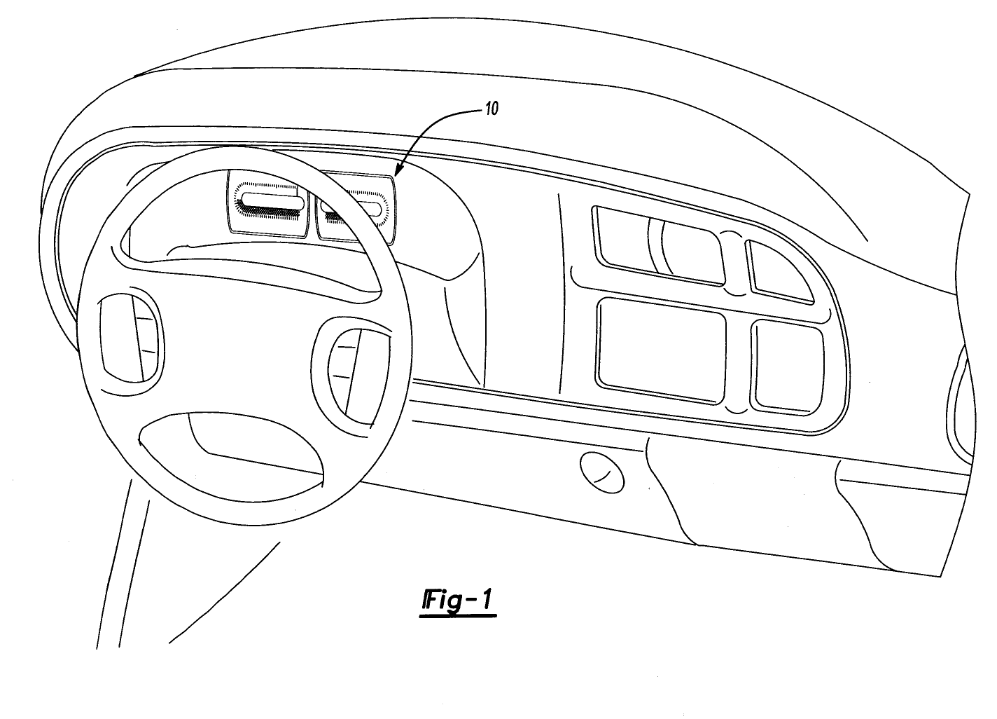

FIG. 1 is a perspective view of display system 10 for vehicle 12. As will be described below, display system 10 provides users a visual indicator of a state, e.g., speed, of vehicle 12.

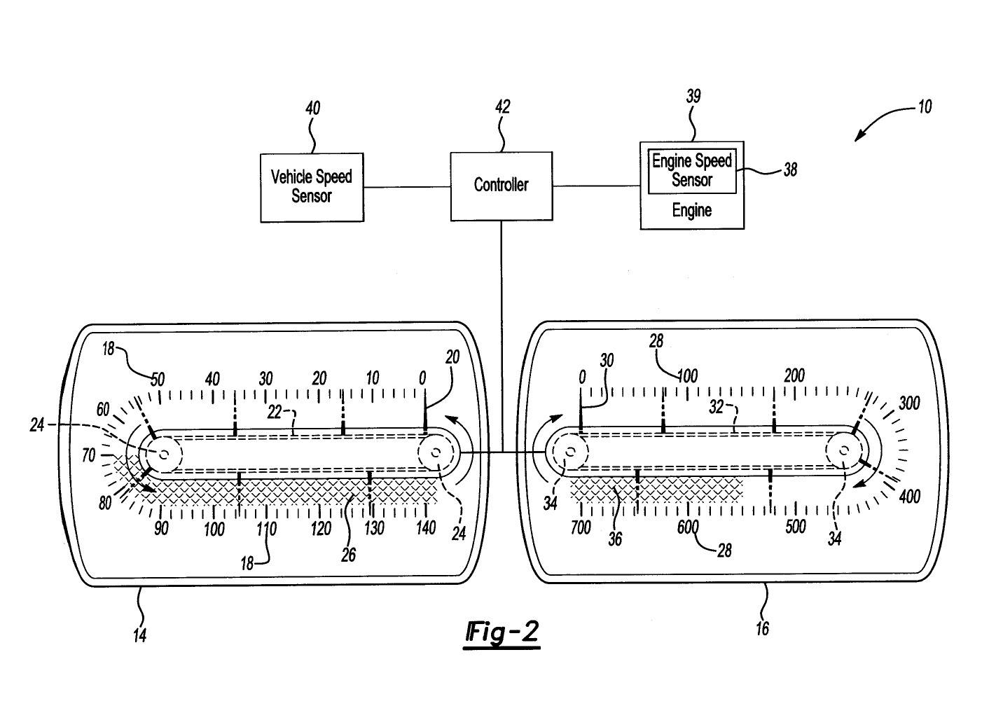

FIG. 2 is an elevation view of display system 10 showing its associated control system in block diagram format. Display system 10 includes speedometer 14 and tachometer 16.

Speedometer 14 includes speed markings 18, which indicate vehicle speed, speed bar 20, belt 22, and pulleys 24. Speed bar 20 is mechanically connected, at its base, with belt 22 which forms a continuous loop around pulleys 24. By moving belt 22 in the counterclockwise (or clockwise) direction, as indicated by the arrows, speed bar 20 moves around speedometer 14 depending on the vehicle speed as will be explained below. Speedometer 14 also includes designated range 26 which, for example, can visually indicate undesirable speeds for vehicle 12.

Tachometer 16 includes tach markings 28, tach bar 30, belt 32, and pulleys 34. Tach bar 30 is mechanically connected with belt 32 which forms a continuous loop around pulleys 34. Tach bar 30, belt 32, and pulleys 34 are configured to operate in a manner similar to that described with reference to speed bar 20, belt 22, and pulleys 24. Tachometer 16 also includes designated range 36 which, for example, may indicate undesirable speeds for engine 38 of vehicle 12.

In some alternative embodiments, speed bar 20 and tach bar 30 may not be mechanically connected with belts 22, 32 respectively. Rather, belts 22, 32 may each have a magnetic feature, e.g., magnet, and bars 20, 30 may each have a magnetic feature, e.g., magnet, such that, for example, as the magnetic feature of belt 22 moves, speed bar 20 moves in response around display system 10. In other alternative embodiments, system 10 may lack belts 22, 32. Bars 20, 30, instead, may be connected to respective tracks each defining a path for the movement of bars 20, 30. Other configurations are also contemplated.

Engine speed sensor 38 of engine 39 and vehicle speed sensor 40 are in communication with controller 42 via, for example, a car area network. Vehicle speed sensor 40 senses vehicle speed, in any conventional fashion, and communicates the vehicle speed information to controller 42. Engine speed sensor 38, likewise, senses engine speed, in any conventional fashion, and communicates the engine speed information to controller 42.

Controller 42, e.g., processors and associated control motors, is operatively connected with pulleys 24, 34, such that pulleys 24 will move counterclockwise as vehicle speed increases and clockwise as vehicle speed decreases. Likewise, pulleys 34 will move clockwise as engine speed increases and counterclockwise as engine speed decreases.

In the embodiment of FIG. 2, speed bar 20 will translate from right to left as vehicle speed increases from 0 miles per hour to 50 miles per hour, will rotate counterclockwise as vehicle speed increases from 50 miles per hour to 90 miles per hour, and will translate from left to right as vehicle speed increases from 90 miles per hour to 140 miles per hour. Speed bar 20 will move in directions opposite to those described above as vehicle speed decreases. Tach bar 30 will translate from left to right as engine speed increases from 0 revolutions per minute to 250 revolutions per minute, will rotate clockwise as engine speed increases from 250 revolutions per minute to 460 revolutions per minute, and will translate from right to left as engine speed increases from 460 revolutions per minute to 700 revolutions per minute. Tack bar 30 will move in directions opposite to those described above as engine speed decreases. In other embodiments, indicator bars, e.g., speed bar 20, may translate and/or rotate as desired.

Display system 10 may include fewer or more indicators, e.g., engine temperature, ambient temperature, etc.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A display system for an automotive vehicle comprising:
a sensor arrangement configured to determine a state of the vehicle;
a display including indicia indicative of the state of the vehicle; and
an indicator element associated with the display and operatively connected with the sensor arrangement such that the indicator element indicates the state of the vehicle by its position relative to the indicia, the indicator element being configured to translate in a first direction as the state of the vehicle increases, if the state of the vehicle is less than a first predetermined threshold, to rotate as the state of the vehicle increases, if the state of the vehicle is greater than the first predetermined threshold and less than a second predetermined threshold, and to translate in a second direction as the state of the vehicle increases, if the state of the vehicle is greater than the second predetermined threshold.

2. The system of claim 1 wherein the indicator element is further configured to translate in a direction opposite the second direction as the state of the vehicle decreases, if the state of the vehicle is greater than the second predetermined threshold, to rotate as the state of the vehicle decreases, if the state of the vehicle is less than the second predetermined threshold and greater than the first predetermined threshold, and to translate in a direction opposite the first direction as the state of the vehicle decreases, if the state of the vehicle is less than the first predetermined threshold.

3. The system of claim 1 wherein the first direction is different than the second direction.

4. The system of claim 1 wherein the second direction is opposite the first direction.

5. The system of claim 1 wherein the state of the vehicle is vehicle speed.

6. The system of claim 1 wherein the vehicle includes an engine and wherein the state of the vehicle is engine speed.

7. The system of claim 1 further comprising a looped belt attached with the indicator element and configured to cause the indicator element to translate in the first and second directions.

8. A speedometer system for an automotive vehicle comprising:
a display including indicia indicative of vehicle speed;
an indicator element associated with the display and configured to indicate vehicle speed by its position relative to the indicia; and
a looped belt attached with the indicator element and configured to cause the indicator element to translate in a first direction as vehicle speed increases, if the vehicle speed is less than a first predetermined vehicle speed, to rotate as the vehicle speed increases, if the vehicle speed is greater than the first predetermined vehicle speed and less than a second predetermined vehicle speed, and translate in a second direction as the vehicle speed increases, if the vehicle speed is greater than the second predetermined vehicle speed.

9. The system of claim 8 wherein the looped belt is further configured to cause the indicator element to translate in a direction opposite the second direction as the vehicle speed decreases, if the vehicle speed is greater than the second predetermined vehicle speed, to rotate as the vehicle speed decreases, if the vehicle speed is less than the second predetermined vehicle speed and greater than the first predetermined vehicle speed, and to translate in a direction opposite the first direction as the vehicle speed decreases, if the vehicle speed is less than the first predetermined vehicle speed.

10. The system of claim 8 wherein the first direction is different than the second direction.

11. The system of claim 8 wherein the second direction is opposite the first direction.

12. A tachometer system for an automotive vehicle having an engine comprising:
a display including indicia indicative of engine speed;
an indicator element associated with the display and configured to indicate engine speed by its position relative to the indicia; and
a looped belt attached with the indicator element and configured to cause the indicator element to translate in a first direction as engine speed increases, if the engine speed is less than a first predetermined engine speed, to rotate as the engine speed increases, if the engine speed is greater than the first predetermined engine speed and less than a second predetermined engine speed, and translate in a second direction as the engine speed increases, if the engine speed is greater than the second predetermined engine speed.

13. The system of claim 12 wherein the looped belt is further configured to cause the indicator element to translate in a direction opposite the second direction as the engine speed decreases, if the engine speed is greater than the second predetermined engine speed, to rotate as the engine speed decreases, if the engine speed is less than the second predetermined engine speed and greater than the first predetermined engine speed, and to translate in a direction opposite the first direction as the engine speed decreases, if the engine speed is less than the first predetermined engine speed.

14. The system of claim 12 wherein the first direction is different than the second direction.

15. The system of claim 12 wherein the second direction is opposite the first direction.
